(19) United States
(12) Patent Application Publication
(10) Pub. No.: US 2004/0050507 A1
(43) Pub. Date: Mar. 18, 2004

(54) Thermal insulating window and entrance portable cover/pad

(76) Inventor: Donald Lee Thomas, Hampton, VA (US)

Correspondence Address: DONALD LEE THOMAS, 2508 VICTORIA BLVD., HAMPTON, VA, 23661, US

(21) Appl. No.: 10/241,855

(22) Filed: Sep. 13, 2002

(51) Int. Cl. E06B 9/00

(52) U.S. Cl. 160/368.1

(57) ABSTRACT

An inexpensive lightweight reusable detachable insulating cover device for residential and commercial dwellings and similar heated structures. The inner-portion of the insulating pad (02) will fit inside of a typical entrance or window unit (21) framing. The outer-portion of the insulating pad (01) will overlap the window unit or entrance framing. The outer portion of the insulating pad shall be secured to the building wall structure (20) surrounding the window or entrance framing by using Velcro Fasteners (06). During cold weather months, the present invention will greatly restrict warm air from escaping between small crevices in inept window systems by fitting firmly into window framing using a insulating material, whereby creating a thermal barrier and improving the efficiency of the furnace thus creating a decrease in electricity or fuel consumption.

### BACKGROUND

1. Field of Invention

This invention relates to detachable insulating covers that are particularly suited for use in connection with windows and entrances of residential and commercial dwellings.

2. Prior Art

It is known from prior art that heat transfer through the windows and entrances of residential and commercial dwellings can be greatly reduced through the use of insulating covers.

Prior art has shown application of thin sheets of transparent plastic-like material affixed to the windows and entrances. This method does offer some thermal insulation properties however; in older dwellings with inept windows and entrances this method will have very little if any effect. In addition this application has problems with condensation build-up when in use.

Another solution of prior art in U.S. Pat. No. 4,610,292 (1986) suggested the use of insulated window shades and curtains. In this method window shades have a separate or detachable insulating layer behind the cloth fabric of shade or curtain. The insulating layer could be added during winter months and removed during the warmer months. This method did offer a portable way of insulating window areas however; this method did very little for drafty inept window systems for older dwellings. In cold weather months if an furnace is used to heat the dwelling, the produced warm air will rapidly escape through the drafty windows making it uncomfortable and thereby lowering the efficiency of the furnace or requiring a greater increase in fuel consumption to warrant eliminating the problem.

Another solution of prior art in U.S. Pat. No. 4,131,150 (1978) suggested the use of a window enclosure that is permanently mounted inside of window framing, the window enclosure used siding panels to remove or add insulating material. This method required a permanent alternation to the window framing.

These methods listed above are known to suffer from the following disadvantages:

(a) Poor thermal protections during cold weather months, by permitting warm air to escape between small crevices in inept window systems.

(b) Either system is designed to have an insulating layer fit firmly inside the window framing while utilizing surrounding wall element for fastening without altering the window and/or framing itself.

### SUMMARY OF THE INVENTION—OBJECTS AND ADVANTAGES

A need for a long period of time has existed for a portable window insulating system that is simple and cost effective to install at first application, which will not alter the current window or entrance framing.

A important object of the present invention is to enable a person to remove the cover from the window framing is a simple manner.

Another important object of this invention is to provide a thermal barrier which seals around the edges of the window framing with a insulating layer and which may be adjusted to overlap around window framing edges onto the adjacent wall area.

During cold weather months the present invention, when installed inside a dwelling, will greatly restrict warm air and radiant heat from escaping between small crevices in inept window systems by fitting firmly into window framing using an insulating material.

This lightweight portable and removable insulating cover is placed over the interior-side generally (or the exterior) of typical commercial and residential building windows and entrances, providing added thermal protection inside of the dwelling, whereby creating a thermal barrier.

The present invention could be modified to have a viewer's opening for viewing out of the window/entrance when cover is installed. The present invention can also be modified to have decorative designs or embroidery on the exterior of device that is attractive and decorative to the eye of the beholder on the interior or exterior of the house.

This insulating cover can also be fabricated as a solid one-piece pre-molded insulating material using various molding/casting manufacturing techniques or using various fibrous felt-type insulating materials.

It is still another object of this invention to provide a complete window assembly that is simple, reusable, easy and economical to maintain.

This invention will be better understood and appreciated from the following detailed description of one embodiment thereof, selected for purposes of illustration and shown in the accompanying drawings.

### BRIEF DESCRIPTION OF THE DRAWINGS

FIG. 1 is a perspective view of Thermal Insulating Window and Entrance Portable Cover/Pad of the present invention.

FIG. 2 is a partial elevation view showing the installation of present invention covering the interior side of a window unit 21 inside a building.

FIG. 2A is a modified version of FIG. 2 showing a Viewer's Opening option for the present invention.

FIG. 3 is a cross sectional transverse view of window unit showing Insulating Cover insertion taken along lines 3-3 of FIG. 2.

FIG. 4 is detailed orthographic embodiment of the Thermal Insulating Window and Entrance Portable Cover/Pad of FIG. 1

FIG. 5 is a Typical Installation and Application Method for the present invention.

FIG. 6 is a cross-sectional view showing the thermal insulating cover insertion along lines 6-6 of FIG. 2.

FIG. 6A is an alternative method of installing the present invention by using an Extension Adapter, whereby permitting the present invention to be installed over irregular, large and over-sized window units.

FIG. 6B is a perspective view of the Extension Adapter identified in FIG. 6A.

Reference Numerals In Drawings

Reference Numerals In Drawings

01 Outer Portion of Pad
02 Inner Portion of Pad
03 Fabric Material
04 Heavy Duty Nylon Threading Material
05 Buttons with Threading Holes
06 Velcro Fasteners
07 Polyester Filler Batting (Fibrous)
08 Aluminum Foil (General-use Grade)
09 Fiberglass Felt-type Insulation
10 Extension Adapter
20 Building Wall Structure
21 Window Unit
22 Viewer's Opening

### DESCRIPTION OF THE PREFERRED EMBODIMENT

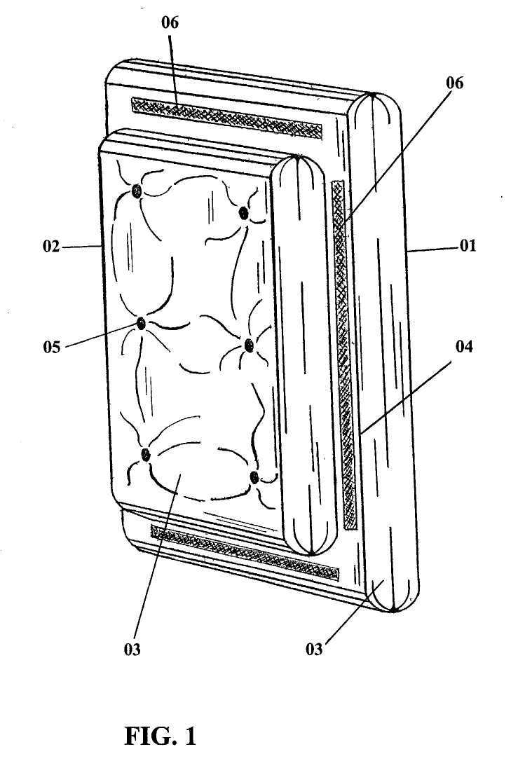

FIG. 1 shows Thermal Insulating Window and Entrance Portable Cover/Pad which comprises a insulating core-element fabricated utilizing two functional sections which are the Outer Portion of Pad 01 and the Inner Portion of Pad 02. Both Pads are completely encased in a Fabric Material 03. All seams, corners, and edges of the Fabric Material 03 are bound together using Heavy-duty nylon threading material 04. Spaced uniform along topside of the Inner Portion of Pad 02 are Buttons with Threading Holes 05. Another set Buttons with Threading Holes 05 are placed on the backside of the Outer Portion of Pad 01, which is spaced in a manner in that they are directly aligned with Buttons with Threading Holes 05 of the Inner Portion of Pad 02. The Buttons with Threading Holes 05 on both the Outer Portion of Pad 01 and the Inner Portion of Pad 02 are laced together by tightly drawn Heavy-duty Nylon Threading Material 04. The tightly drawn lacing passes through both the Outer Portion of Pad 01 and the Inner Portion of Pad 02. Along the topside perimeter of the Outer Portion of Pad are uniformly spaced Velcro Fasteners 06.

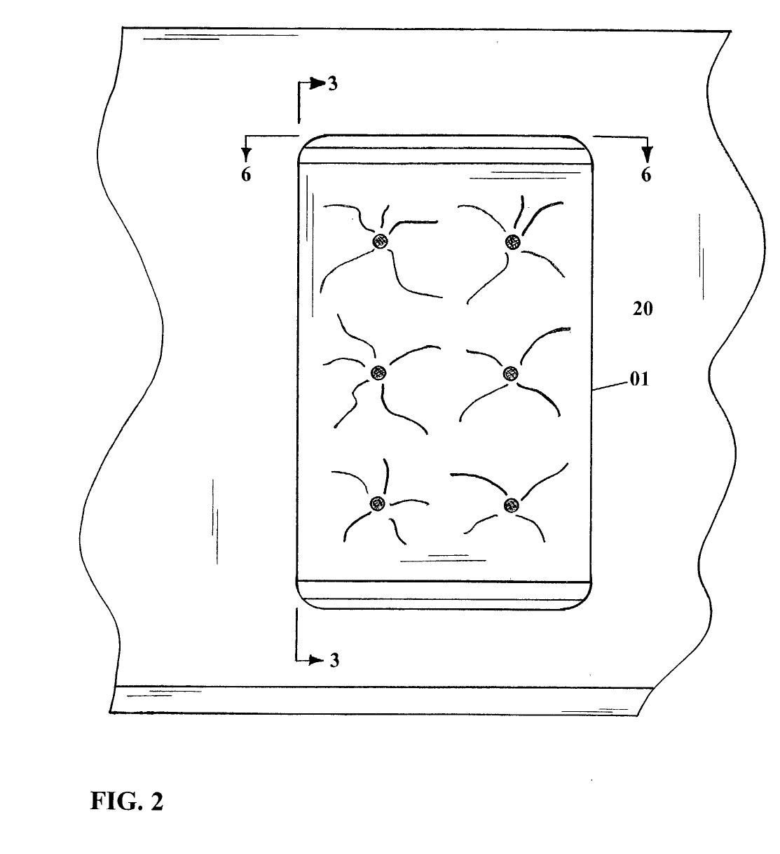

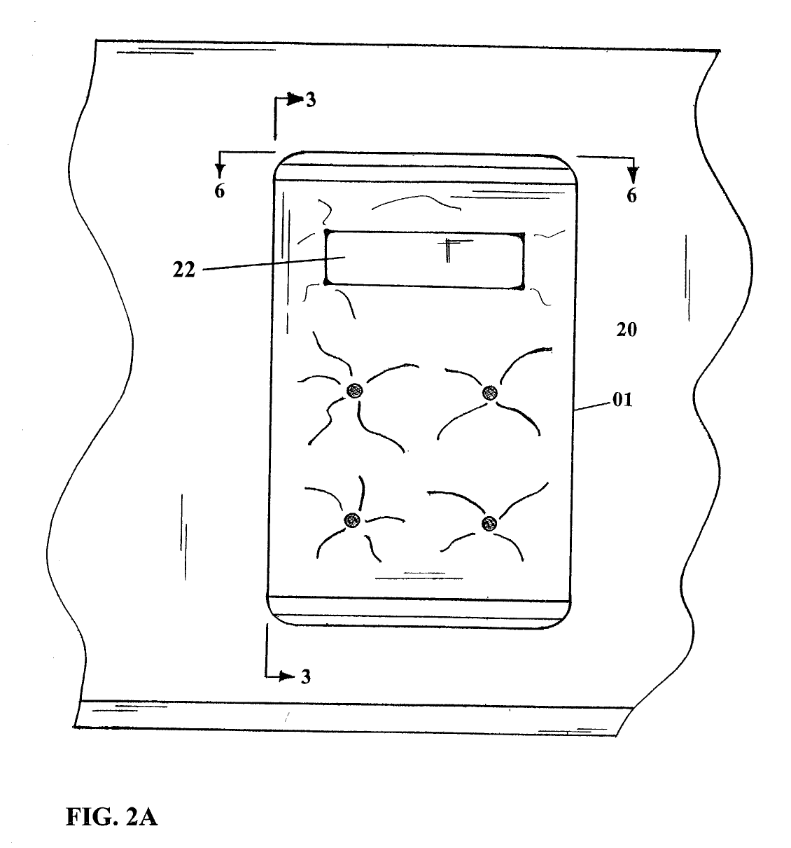

FIG. 2 is a partial elevation view showing a inside Building Wall Structure 20 with the Thermal Insulating Window and Entrance Portable Cover/Pad installed over a Window Unit 21. The Inner Portion of Pad 02 is fitted inside of window framing area The Outer Portion of Pad 01 overlaps onto Building Wall Structure 20 along the edges of the window framing.

FIG. 2A is a modified version of FIG. 2, which is a partial elevation view showing a Building Wall Structure 20 with the Thermal Insulating Window and Entrance Portable Cover/Pad installed over a Window Unit 21. The Inner Portion of Pad 02 is fitted inside of window framing area. The Outer Portion of Pad 01 overlaps onto Building Wall Structure 20 along the edges of the window framing.

This drawing also shows a Viewer's Opening 22 which allows the viewer inside a dwelling to view the environment on the outside of the dwelling when the present invention is installed. The Viewer's Opening 22 shall be fabricated cuffing a opening completely through the insulating cover then sealing the exposed Fiberglass Insulation 09 and Polyester Filler Batting 07 by encasing them with fabric material 03, all seams shall be bound together by using Heavy Duty Nylon Threading Material 04.

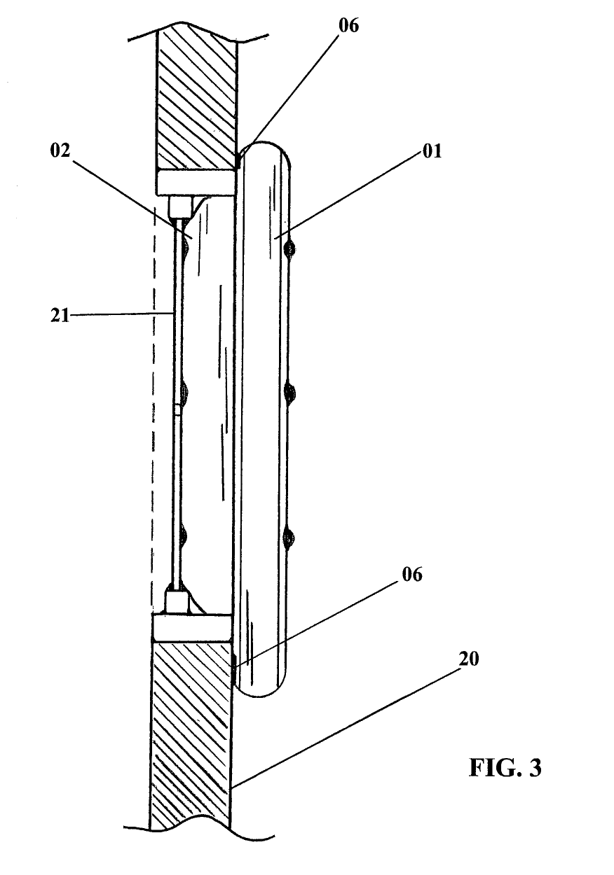

FIG. 3 is a cross sectional transverse view of Window Unit 21 and the Insulating Window and Entrance Portable Cover/Pad taken along 3-3 of FIG. 2. The Inner Portion of Pad 02 is fitted inside of window framing area. The Outer Portion of Pad 01 overlaps onto Building Wall Structure 20 along the edges of the window unit 21 framing. Along the perimeter of the Building Wall Structure 20 encircling the window unit 21 are mounted Velcro Fasteners 06. These Velcro Fasteners 06 are firmly attached using matching spacing to Velcro Fasteners 06 attached the topside of the Outer Portion of Pad 01. All sides and corners of Outer Portion of Pad 01 are checked to make sure that all Velcro Fasteners 06 are attached to Velcro fasteners 06 mounted to Building Wall Structure 20 encircling the Window Unit 21.

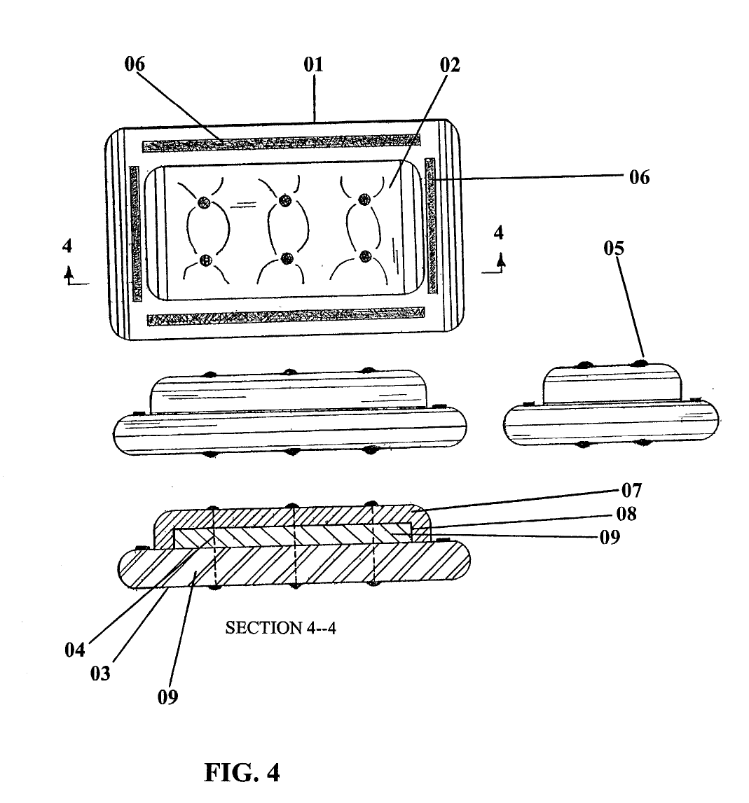

FIG. 4 is detailed orthographic and cross-sectional embodiment of the Thermal Insulating Window and Entrance Portable Cover/Pad. The orthographic embodiment shows the relationship and arrangement of the Outer Portion of Pad 01 to the Inner Portion of Pad 02.

Cross-sectional view taken along lines 4-4 show the internal features of the present Invention. The Inner Portion of Pad 02 internally is fabricated mostly comprising of Polyester Filler Batting 07. A sheet of General-Use grade Aluminum Foil 08 is sandwiched between the Polyester Filler Batting 07 and the Fiberglass Felt-type Insulation 09. The Outer Portion Of Pad 01 internally is fabricated comprising Fiberglass Felt-type Insulation 09. The outer surfaces of both the Outer Portion of Pad 01 and Inner Portion of Pad are completely encased in a Fabric Material 03. Spaced uniform along topside of the Inner Portion of Pad 02 are Buttons with Threading Holes 05. A second set of Buttons with Threading Holes 05 are placed on the backside of the Outer Portion of Pad 01, which is spaced in a manner in that they are directly aligned with Buttons with Threading Holes 05 of the Inner portion of Pad 02. The Buttons with Threading Holes 05 on both the Outer Portion of Pad 01 and the Inner Portion of Pad 02 are laced together by tightly drawn Heavy-duty Nylon Threading Material 04. This sectional view shows the tightly drawn lacing passing through both the Outer Portion of Pad 01 and the Inner Portion of Pad 02. Along the topside perimeter of the Outer Portion of Pad 01 are uniformly spaced Velcro Fasteners 06.

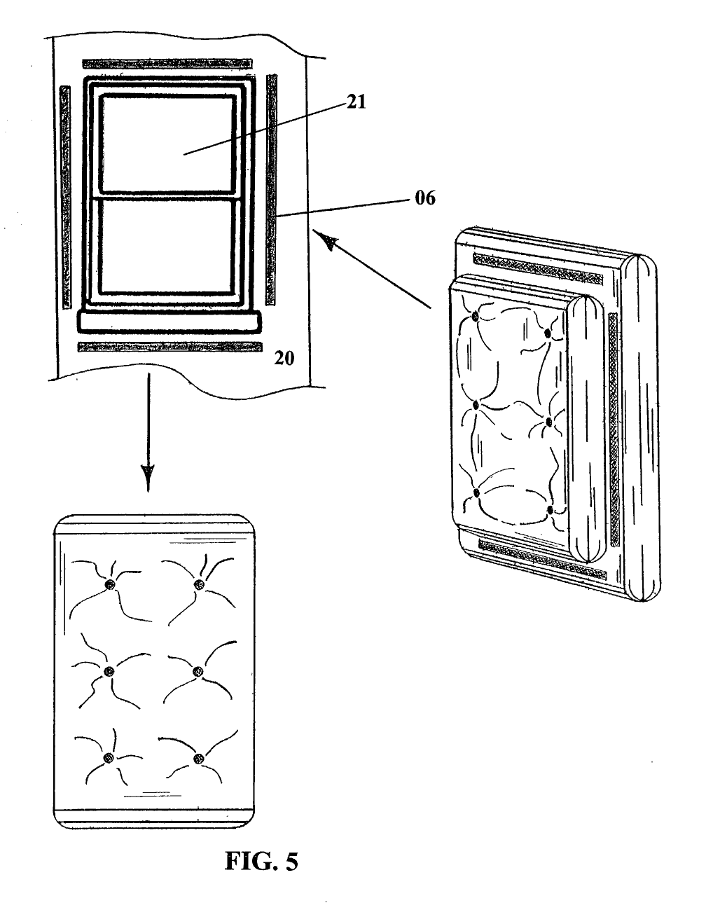

FIG. 5 shows the Thermal Insulating Window and Entrance portable Cover/Pad's typical installation method. The present invention is mounted over the Window Unit 21 with the Inner Portion of Pad 02 fitting inside Window Unit 21 framing. This Embodiment shows an elevation view of Velcro Fasteners 06 installed on the Building wall structure 20 which surround the Window Unit 21.

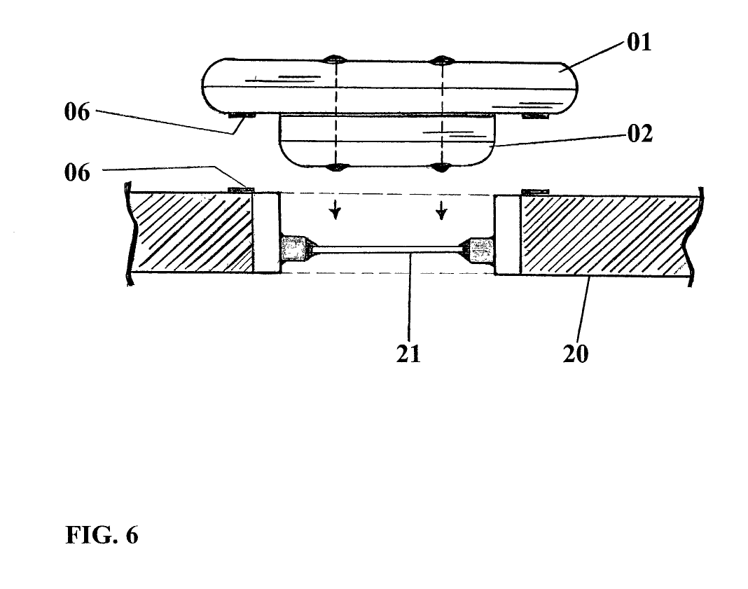

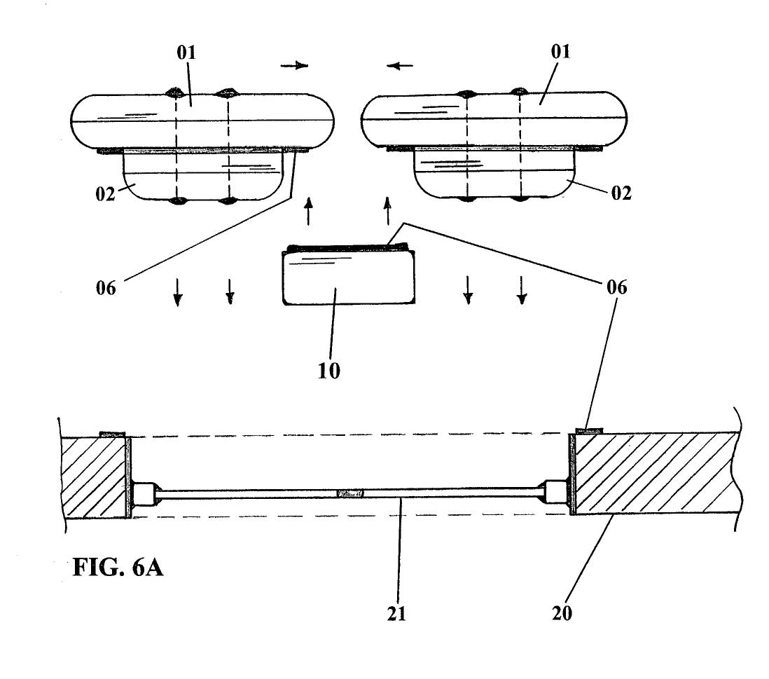

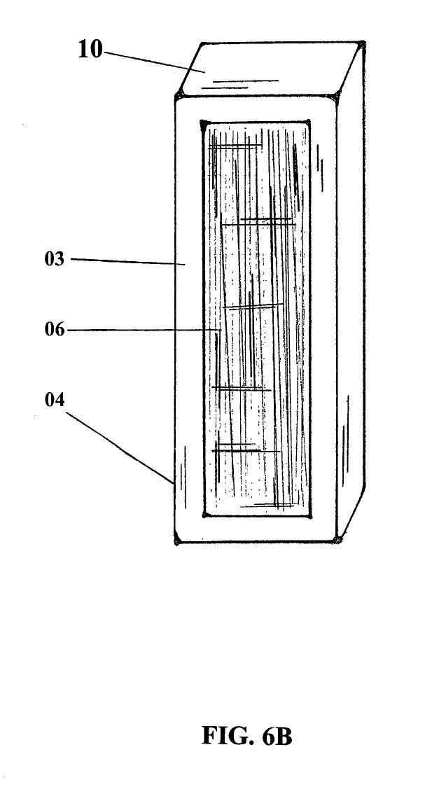

FIG. 6 is a longitudinal cross-section view of the building wall structure 20 and Window Unit 21 taken along 6-6 of FIG. 2. This view shows the insertion of the Thermal Insulating Window and Entrance Portable Cover/Pad into the framing of Window Unit 21. This cross-sectional view also shows the alignment of the Velcro fasteners 06 surrounding the Window Unit 21 framing and Velcro fasteners 06 attached to the top-side of outer portion of pad 01.

FIG. 6A is a modified version of FIG. 6 which is a longitudinal cross-section view of the building wall structure 20 and Window Unit 21 taken along 6-6 of FIG. 2. This view shows the insertion of the Thermal Insulating Window and Entrance Portable Cover/Pad into the framing of Window Unit 21. In addition to the features explained in FIG. 6, this modified version shows the present invention insertion for an over-sized window unit 21 using the Extension Adapter 10. This is a bridging device to attach two insulating covers, whereby permitting the present invention to be expandable and extendable for installation over irregular, large or over-sized window unit 21. The Extension Adapter 10 is rectangular and elongated in proportion with one elongated side having a Velcro Fastener 06 attached to its exterior surface. The general length of the Extension Adapter 10 shall be proportional to the length of the joining Inner Portion of Pads 02 of the present invention. The general width of the Extension Adapter 10 shall be proportional to general distance between the joining Inner Portion of Pads 02 of the present invention while the joining Outer Portion of Pads 01 of the present invention are directly in contact. The elongated side of Extension Adapter 10 with the attaching Velcro Fastener 06 shall be firmly connected to the Velcro Fastener 06 attached along the common perimeter on the topside of the joining Outer Portion of Pads 01 of the present invention.

FIG. 6B is a perspective view of the Extension Adapter 10 identified in FIG. 6A. The Extension Adapter 10 is comprised of Fiberglass Felt-type Insulation 09 core element, which is encased in Fabric Material 03. All seam, corners, and edges of the Fabric Material 03 are bound together using Heavy-duty nylon threading material 04. The Extension Adapter 10 is rectangular and elongated in proportion with one elongated side having a Velcro Fastener 06 attached to its outer surface along its length.

Summary, Ramifications, and Scope

As previously mentioned the following reference part numerals have additional advantages in that;

Fabric material 03 may be made of any suitable material such as flame-retardant material, cotton, plastic, polyester, paper with aluminum foil backing, nylon, and the like.

The fiberglass felt-type insulation 09 may be any conventional type of insulation such as fiberglass, fiberglass sheets with aluminum foil or its equivalent, various plastic foams, foam rubber, and any conventional insulation material including flame retardant material, which can control the transfer of heat and prevent the escape of warm air from the interior of the dwelling.

In addition to Velcro fasteners 06, snaps, hooks, or any other types of conventional fastening means could be used.

While Nylon threading material 04 has been mentioned, it will be obvious that in addition to nylon threading material 04, snap fasteners, staples, epoxy or other glue-like material or heat seals can be used.

A particular advantage of the present invention lies in the fact that edge portion of the outer pad 01 proficiently seals around the edges of the window unit 21. This seal greatly restricts the passage of warm air from inside the dwelling and is easily removable. If the fasteners 06 are appropriately spaced along the window unit framing 21, the insulating section of the present invention will greatly improve the air tightness of the space between the window unit 21 and the insulating cover.

Referring to FIG. 5 Velcro fasteners 06 are shown attached to the wall area surrounding window unit 21. These fasteners could also be mounted directly to the window unit 21 framing. This method could benefit fixed sash commercial window units with metal framing.

The Outer Portion of Pad 01 could be constructed omitting the Fiberglass Insulation 09 shown in FIG. 4, thus just using a layer of fabric material 03 or vinyl and plastic-like materials. This method would provide a smooth, flush and sleek appearance inside of the dwelling, thus lending itself to various decorative and ornamental designs, patterns, pictures, textures, writings and embroidery.

Also an additional advantage of the present invention lies in the fact that the materials selected to manufacture this device; when used in combination could produce stain resistant, water-resistant and moisture-resistant properties which would improve the effectiveness of the device. This could include the Fabric Material 03, Fibrous Polyester Filler Batting 07, and Fiberglass Insulation 09.

Also an additional advantage of the present invention lies in the fact that the materials selected to manufacture this device; when used in combination could make the device a bullet-proof or resistant barrier when installed at windows and entrances. T his ramification could have great law enforcement and military potential.

Although the description above contains many specifics, these should not construed as limiting the scope of the present invention but as merely providing illustrations of the presently preferred embodiments.

Thus the scope of this invention should be determined by the appended claims and their legal equivalents, rather than by the examples given.

I claim the following:

1. A lightweight reusable easily attachable and detachable insulating cover device particularly suited for application to windows, entrances and comparable building wall structures of residential and commercial dwellings, buildings, including similar heated and non-heated structures, where convective and radiant heat loss is to be minimized, the insulating cover comprising:
an insulating material means constructed, arranged and adjusted to a sufficient thickness, size and flexibility so shaped and proportioned to be adapted to said windows, entrances or comparable building wall structures.
a fastening means mounted to wall elements of said windows, entrances and comparable building wall structures including its framing and said insulating cover arranged in a manner to allow the said insulating cover to be easily adjustable, extendable, attachable, detachable, energy efficient and restrict air movement.
Whereby creating a thermal barrier thus minimizing heat loss by efficiently restricting the escape of warm air and radiant heat through said windows, entrances and comparable building wall structures.

2) The lightweight reusable easily attachable and detachable insulating cover device as defined in claim 1 further characterized by application to windows, entrances and comparable building wall structures of residential and commercial dwellings, buildings, including similar air-conditioned and non-air conditioned structures, where spaces are to remain comfortable by minimizing the lost of cooled air, the insulating cover comprising:
an insulating material means constructed arranged and adjusted to a sufficient thickness, size and flexibility so shaped and proportioned to be adapted to said windows, entrances and comparable building wall structures.
a fastening means mounted to wall elements of said windows, entrances and comparable building wall structures including its framing and said insulating cover arranged in a manner to allow the said insulating cover to be easily adjustable, extendable attachable, detachable, energy efficient and restrict air movement.
Whereby creating a thermal barrier thus minimizing the loss the air conditioning produced cooled air by efficiently restricting the escape of the air through said windows, entrances or comparable building wall structures.

3) The lightweight easily attachable and detachable insulating cover device as defined in claim 1 further characterized by outer portion of pad,
means to provide a thermal barrier, which seals around the edges of the said windows, entrances and comparable building wall structures with a attaching layer of sufficient thickness, which may be adjusted to overlap around these edges onto the adjacent wall area

4) The outer portion of pad as defined in claim 3 further characterized here in,
a means to provide a thermal barrier, which seals around the edges of the said windows, entrances and comparable building wall structures with a attaching layer of sufficient thickness, which may be adjusted and attached onto the said windows, entrances and comparable building wall structures framing.

5) The lightweight easily attachable and detachable insulating cover device as defined in claim 1 further characterized by inner portion of pad, means to restrict air and radiant heat from escaping by fitting firmly into said windows, entrances and comparable building wall structures framing using said insulating material.

6) The lightweight easily attachable and detachable insulating cover device as defined in claim 1 further characterized by fabric material,
means for encasing the said insulating material and internal components of said insulating cover whereby preserving the said insulating material and said internal components of said insulating cover from damage and dissociating and also provide thermal properties when used in combination with said insulating cover.

7) The lightweight easily attachable and detachable insulating cover device as defined in claim 1 further characterized by heavy-duty nylon threading material,
means for bounding together all seams, corners, and edges of the said fabric material and lacing, whereby preserving the insulating material and said internal components of said insulating cover from damage and dissociating and when used in combination with fabric material.

8) The lightweight easily attachable and detachable insulating cover device as defined in claim 1 further characterized by buttons with threading holes spaced uniform along topside of the said inner portion of pad, another set of said buttons with threading holes are placed on the backside of the said outer portion of pad, which is spaced in a manner in that they are directly aligned with said buttons with threading holes of the said inner portion of pad. The said buttons with threading holes on both the said outer portion of pad and the said inner portion of pad are laced together by tightly drawn said heavy-duty nylon threading material. The tightly drawn lacing passes through both the said outer portion of pad and the said inner portion of pad, thus providing a means for the said insulating cover to maintain its determined shape.

9) The lightweight easily attachable and detachable insulating cover device as defined in claim 1 further characterized by Velcro fasteners which are uniformly spaced along the topside perimeter of the said outer portion of pad and mounted to wall elements surrounding the said windows, entrances and comparable building wall structures being arranged in a manner to allow the said insulating cover to be easily adjustable, extendable attachable, detachable, energy efficient and restrict air movement once installed.

10) The Velcro fasteners as defined in claim 9 further characterized here in,
Velcro fasteners which are uniformly spaced along the topside perimeter of the said outer portion of pad and mounted to framing of the said windows, entrances or comparable building wall structures being arranged in a manner to allow the said insulating cover to be easily adjustable, extendable attachable, detachable, energy efficient and restrict air movement once installed.

11) The lightweight easily attachable and detachable insulating cover device as defined in claim 1 further characterized by polyester fibrous filler batting,
means to restrict air and radiant heat from escaping between small crevices in window systems by fitting firmly into window framing used in combination with said insulating material and said fabric material.

12) The lightweight easily attachable and detachable insulating cover device as defined in claim 1 further characterized by aluminum foil,
means to create a thermal barrier thus minimizing heat loss by efficiently restricting the escape of warm air and radiant heat through said windows, entrances or comparable building wall structures when used in combination with said insulating material, said fabric material and said polyester filler batting.

13) The lightweight easily attachable and detachable insulating cover device as defined in claim 1 further characterized by fiberglass felt-type insulation,
means to create a thermal barrier thus minimizing heat loss by efficiently restricting the escape of warm air and radiant heat through said windows, entrances and comparable building wall structures, thus serving as the insulating core element material when used in combination with said fabric material and fibrous polyester filler batting.

14) The lightweight easily attachable and detachable insulating cover device as defined in claim 1 further characterized by the extension adapter,
a bridging means to attach two or more said insulating covers, whereby permitting the present invention to be expandable and extendable for installation over irregular, over large, and over-sized said windows, entrances and comparable building wall structures

15) The lightweight easily attachable and detachable insulating cover device as defined in claim 1 further characterized by the viewer's opening,
means to allow viewers inside and outside of said residential and commercial dwellings, buildings, including similar heated and non-heated structures to view the environment on the inside and outside of the dwelling when the said insulating cover is installed over said windows, entrances and comparable building wall structures.

16) The lightweight easily attachable and detachable insulating cover device as defined in claim 1 further characterized by the exterior surface of said outer portion of pad and the exterior surface of the said inner portion of pad of the said insulating cover having various decorative and ornamental designs, patterns, pictures, textures, writings and embroidery, thus including the entire exterior surface of said insulating cover and said buttons with threading holes.

17) The lightweight easily attachable and detachable insulating cover device as defined in claim 1 further characterized by said insulating cover being moisture-resistant, water-resistant, stain-resistant, flame retardant and reflective.

18) The lightweight easily attachable and detachable insulating cover device as defined in claim 1 further characterized by said insulating cover being constructed of selected materials making said insulating cover a bullet-proof or bullet resistant barrier, which will reject the penetration of a ballistic projectile when installed at said windows, entrances and comparable building wall structures framing.

19) The lightweight easily attachable and detachable insulating cover device as defined in claim 1 further characterized by the exterior surface of said insulating cover being made of a plastic-like material, vinyl and similar materials.
